(19) United States
(12) Patent Application Publication
(10) Pub. No.: US 2003/0117447 A1
(43) Pub. Date: Jun. 26, 2003

(54) Individually locked cells on a spreadsheet

(76) Inventors: P. Gayle Mujica, Allen, TX (US); Michelle A. Miller, Plano, TX (US)

Correspondence Address: TEXAS INSTRUMENTS INCORPORATED, P O BOX 655474, M/S 3999, DALLAS, TX, 75265

(21) Appl. No.: 10/028,813

(22) Filed: Dec. 21, 2001

(51) Int. Cl. G09G 5/00

(52) U.S. Cl. 345/864

(57) ABSTRACT

A computer spreadsheet application program on a graphing calculator or other computer that allows the user to lock and unlock individual or blocks of cells, and identifies those cells to the user. Similarly, other embodiments include the same user interface functionality in a ROM software application package that is executed on a graphing calculator or other handheld device.

### TECHNICAL FIELD OF THE INVENTION

This invention relates to electronic computing devices and spreadsheet software on those devices, and more particularly to a calculator that has a spread sheet that allows the user to lock individual cells from being edited while allowing the locked cells to be vied and used.

### BACKGROUND OF THE INVENTION

Electronic calculators have become a common tool for teaching students mathematics. In particular, the advantages of graphing calculators are being utilized in the classroom. Graphing calculators are characterized by a larger screen, which permits the entry of mathematical expressions in a logical format. They also permit graph displays and table displays. They have sophisticated programming capability. They often permit data transmission to other computing devices, directly or via a data storage medium, as well as data collection via various interface protocols.

Particular calculator models are often designed for particular educational levels. For example, a calculator for middle school students might have less advanced features than one designed for older students. However, regardless of the level for which a calculator is designed, a continual goal in designing them is to provide a logical and easy to use interface. Another goal of the user interface is to assist the teacher in instructing students in the classroom environment.

### SUMMARY OF THE INVENTION

The present invention seeks to improve the user interface for a spreadsheet application. This spreadsheet improvement may be helpful in any type of spreadsheet, but is particularly useful in the classroom environment. The disclosed embodiment is a spreadsheet on a handheld calculator but the invention is applicable and useful for all spreadsheet type applications. The invention introduces an improved user interface to allow more flexibility in locking and unlocking individual cells of the spreadsheet.

A particular problem with prior art computer spreadsheets is the locking of individual spreadsheet cells is cumbersome and difficult. Also, locked cells are not easily identifiable. The present invention allows the user to easily lock and unlock individual or blocks of cells, and identifies those cells to the user.

An embodiment of the present invention is an application program on a graphing calculator or other computer, which allows the user to lock and unlock individual or blocks of cells, and identifies those cells to the user. Similarly, other embodiments include the same user interface functionality in a ROM software application package that is executed on a graphing calculator or other handheld device. The calculator in the present invention may otherwise be a conventional graphing calculator or other handheld computer device.

### BRIEF DESCRIPTION OF THE DRAWINGS

FIG. 1 illustrates the front panel of a prior art calculator 10 which incorporates the invention.

FIGS. 2a-c illustrate the basic screen layout of a spreadsheet on a handheld device according to the present invention.

FIGS. 3a-h illustrate the operation of the cell lockout on spreadsheet according to the present invention.

### DETAILED DESCRIPTION OF THE INVENTION

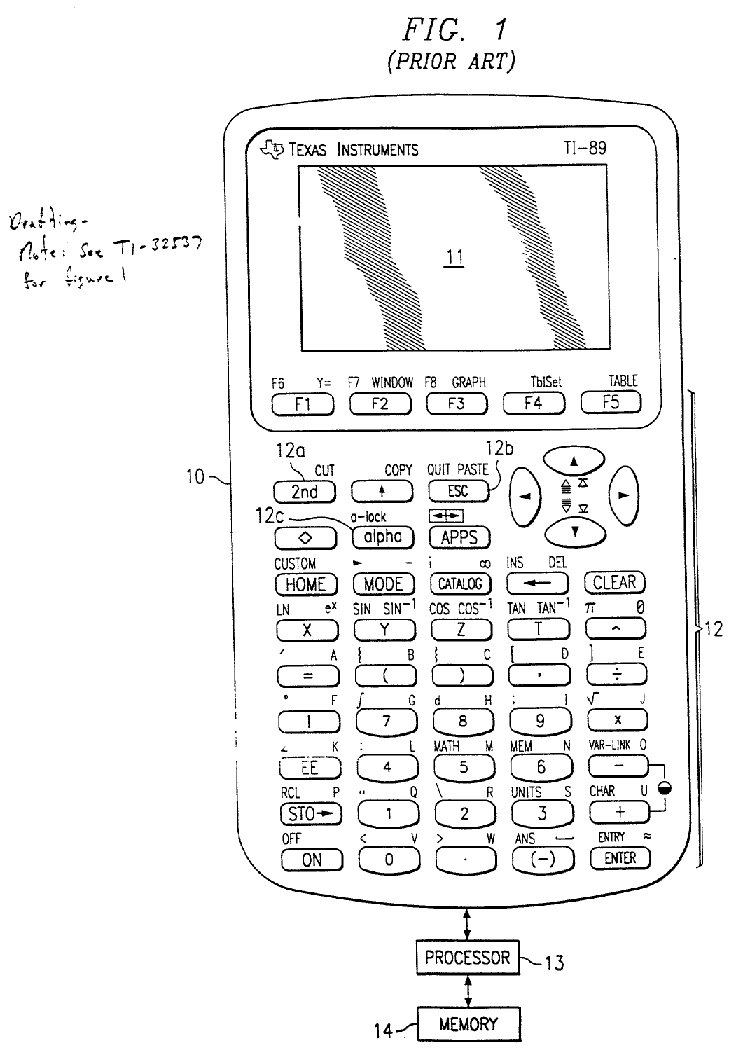

FIG. 1 illustrates the front panel of a calculator 10, which incorporates the features of the present invention. Calculator 10 is described herein in terms of particular software and hardware features of the TI-89, a commercially available graphing calculator manufactured by Texas Instruments Incorporated. Apart from the features of the present invention, many of the features of calculator 10 described herein are typical of graphing calculators, while other features are unique to the TI-89 and TI92 Plus “family” of TI calculators. The use of the TI-89 is for purposes of description, and does not limit the invention. The features that are the subject of the present invention could be incorporated into other calculators that provides graphical displays, or they could be incorporated into other computer based teaching tools and handheld computers.

In FIG. 1, the screen 11 of calculator 10 has a “graphical display”, as that term is used herein. In addition to the ability to draw graphical displays of various types, some of the software features of calculator 10 include, software applications loading and storage, keystroke programming. It also permits data collection, display and analysis.

Various hardware features include a large pixel screen 11, which is 100×160 pixels. A keypad 12 has various keys for data and command entry, some of which are used to implement the invention and are described herein. The calculator includes a processor 13 connected to a memory unit 14 a 256K byte RAM and 721K byte application space. Other features are an I/O port for data linking, and a unit-to-unit link cable connection capability.

As is typical of calculators, calculator 10 has a secondary function key, 2nd key 12a, which permits other keys to have two functions. For example, by pressing 2nd key 12a and then ESC/QUIT key 12b, the calculator performs the QUIT function. For simplicity of explanation herein, a key having two functions is referred to in terms of the function appropriate for the context, i.e., when discussing the QUIT function, the ESC/QUIT key 12b is referred to as the QUIT key 12b. Similarly, calculator 10 has an Alpha key 12c, which when depressed makes the other keys subsequently depressed to input an alpha character.

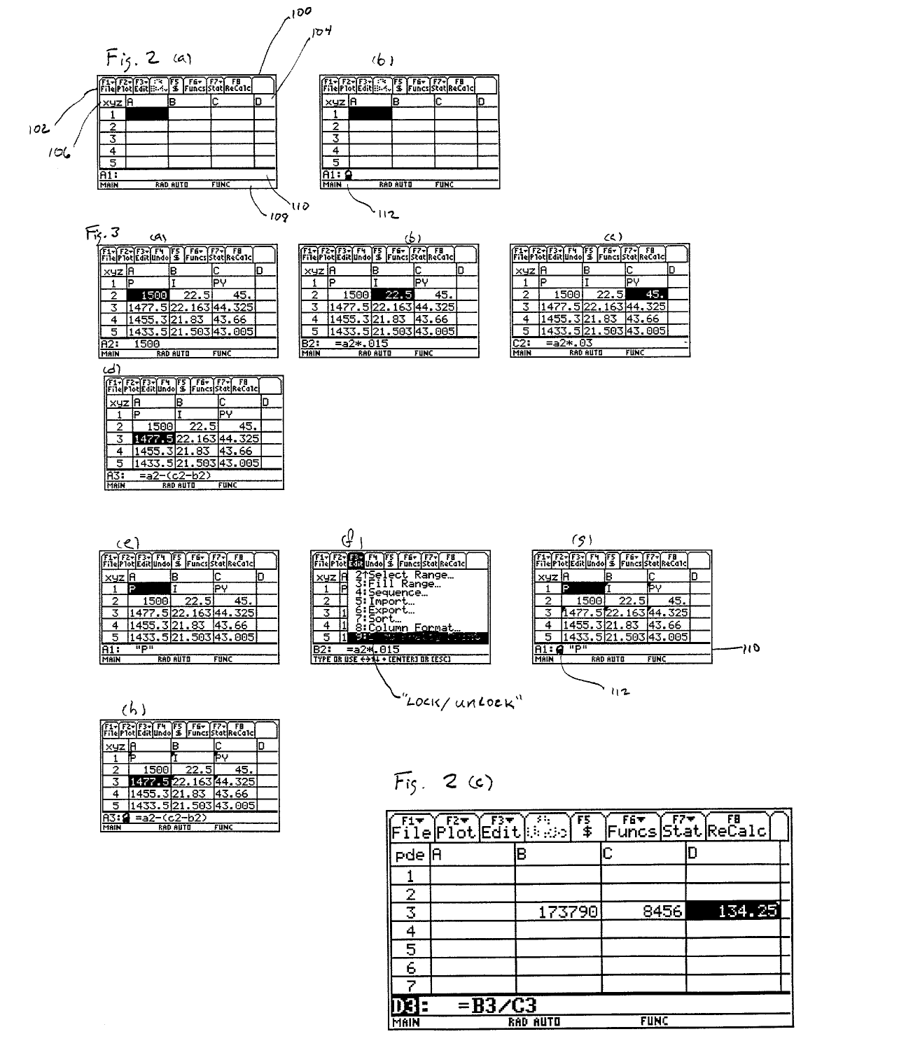

FIG. 2 illustrates an example of the screen display of an embodiment of the present invention. This screen display is typical for the calculator illustrated in FIG. 1 while running an application program called “Cellsheet™.” Cellsheet incorporates a spreadsheet program for a handheld device such as a graphing calculator according to the present invention. Cellsheet combines spreadsheet functionality with the power of a calculator.

The screen display 100 of FIG. 2a shows the screen display after initiating the Cellsheet program. The top area of the screen display 100 shows a menu bar 102 with function tabs for each of the function keys F1 through F8. The main portion of the screen is the spreadsheet rows and columns 104. In this embodiment, there are 64 columns labeled A through BL, where columns A through D are visible on the initial display. The rows are numbered, in this case 1-999, with rows 1 through 5 displayed initially. The upper left hand corner of the spreadsheet 106 identifies name of the current worksheet (XYZ).

On the bottom of the screen 100 is a status line 108. The status line shows various calculator status items such as the open folder (MAIN) and display modes (RAD and AUTO). Above the status bar is the cell edit line 110. The edit line shows the identification of the selected cell or cells and the contents of the cell. In FIG. 2, the cell edit line shows the selected cell as cell A1, and the contents as empty. This line is also used to edit the contents of the cell.

The Cellsheet application program introduces an improved user interface to allow more flexibility in locking and unlocking individual cells of the spreadsheet. A particular problem with prior art computer spreadsheets is the locking of individual spreadsheet cells is cumbersome and difficult. In some spreadsheets, all cells which are to be unlocked must be identified and set unlocked, and then the whole spreadsheet is locked except for those cells that were previously set to unlock. Thus locking a small number of cells may take considerable effort since every unlocked cell must be unlocked first. Also, in the prior art, locked cells are not easily identifiable. The locked status is only shown when the user is unable to modify the cell. The present invention allows the user to easily lock and unlock individual or blocks of cells, and identifies those cells to the user.

Embodiments of the present invention include a cell lock indicator that displays on the screen the lock status of the cells. The cell lock indicator can display the status of only the cursor selected cell, or can be used to indicate the status inside each cell on the screen. For indicating only the cursor selected cell, the cell lock indicator can be an icon or graphical indication such as on the cell edit line. In the illustrated embodiment of FIG. 2b, the cell lock indicator is shown on the cell edit line as a padlock icon. In another embodiment, the cell lock indicator is shown on the cell edit line by inverse video of the cell identifier as shown in FIG. 2c.

Another embodiment of the present invention includes a cell lock indicator that displays on the screen the lock status of the cells. For indicating all locked cells, the cell lock indicator can be a special icon inside the cell, a special font, a special outline or line-type around the cell, or any other graphical indication within the cell or around a locked cell. In another preferred embodiment, the cell lock indicator is a triangular graphic in the upper left corner of each locked cell as shown in FIG. 3g.

In the present invention, a cell or group of cells is locked, or changed to a locked status with a simple lock input. The lock input immediately changes the selected cells to a locked status. The lock input is preferably a singe keystroke or a menu item. A separate unlock input can be used, or the lock input can be a toggle on/off of the selected cells.

FIGS. 3a-h show an example where locked cells are used in a spreadsheet. FIG. 3a shows a spreadsheet which includes a simple worksheet for interest and principle paid on a charge account. Cells A1 through C1 have a text column heading for principle, interest and payment respectively. Cell A2 shows the starting balance of $1500. Cell B2 holds the monthly interest paid, which is the balance times the interest rate of ½ of one percent (0.015) as shown in FIG. 3b. Cell C2 holds the minimum payment percentage multiplied by the balance (a2×0.03) as shown in FIG. 3c. Cell A3 holds the balance after the first payment as shown in FIG. 3d. The remaining cells hold the balance, interest paid and payment for successive months. This is an example of a spreadsheet an instructor may want to download to students, and then allow the students to change some cell contents but have other cells locked to prevent accidental loss of the contents.

An individual cell can be locked as shown in FIGS. 3e-g. The desired cell is selected with the cursor as shown in FIG. 3e. A lock cell input or key is then activated by the user. In the illustrated embodiment, the lock cell input is selected from the edit menu as shown in FIG. 3f by pressing a function key and then selecting the “Lock/Unlock” function. Further, the user could lock a range of cells or block of cells by first selecting all the cells to be locked and then using the “Lock/Unlock” function. A locked cell can be indicated within the cell and/or on the edit line. In the illustrated embodiment, the locked cell status is indicated on the cell edit line 110 by a small padlock icon 112 as shown in FIG. 3g. In the example of FIG. 3, it may be desirable for the instructor to lock several of the cells as shown in FIG. 3h to prevent the student from accidentally changing the contents of the cells. With the user interface of the present invention it is simple to lock several cells and quickly see which cells are locked.

Other Embodiments

Although the present invention has been described in detail, it should be understood that various changes, substitutions, and alterations could be made hereto without departing from the spirit and scope of the invention as defined by the appended claims.

The described embodiment of the present invention is an application program on a graphing calculator, which allows the user to lock and unlock individual or blocks of cells, and identifies those cells to the user. Similarly, other embodiments include the same user interface functionality in a ROM software application package that is executed on a graphing calculator or other handheld device.

What is claimed is:

1. A user interface for a spreadsheet computer program comprising:
a cursor operable by user input which indicates at least one currently selected cell; and
a lock cell input which immediately locks any cell currently selected by the cursor by changing a status of any currently selected cell to a locked status.

2. The user interface of claim 1, wherein the lock cell input toggles the lock status of any cell currently selected by the cursor.

3. The user interface of claim 1, further indicates if at least one currently selected cell has a locked status.

4. The user interface of claim 1, further includes a cell lock indicator associated with the cell of any cell that has a locked status.

5. The user interface of claim 4, further allows the user to turn off and on the cell lock indicator so that any cell that has a locked status will not be indicated in the cell when turned off and will be indicated when turn on.

6. A handheld computing device comprising:
a screen capable of displaying spreadsheet rows and columns for a spreadsheet application;
an input device for operating the computing device and entering user responses;
a processor for executing programming that provides a user interface to the spreadsheet application wherein the user interface further comprises:
a cursor operable by user input through the input device, wherein the cursor indicates at least one currently selected cell; and
a lock cell input which immediately locks any cell currently selected by the cursor by changing a status of any currently selected cell to a locked status.

7. The handheld computing device of claim 6, wherein said processor is further programmed to toggle the lock status of any cell currently selected by the cursor with the lock cell input.

8. The handheld computing device of claim 6, wherein said processor is further programmed to indicate on the screen if at least one currently selected cell has a locked status.

9. The handheld computing device of claim 6, wherein said processor is further programmed to include a cell lock indicator associated with the cell of any cell that has a locked status.

10. The handheld computing device of claim 9, wherein said processor is further programmed to allow the user to turn off and on the cell lock indicator so that any cell that has a locked status will not be indicated in the cell when turned off and will be indicated when turn on.

11. A graphing calculator comprising:
a screen capable of displaying spreadsheet rows and columns for a spreadsheet application;
an input device for operating the computing device and entering user responses;
a processor for executing programming that provides a user interface to the spreadsheet application wherein the user interface further comprises:
a cursor operable by user input through the input device, wherein the cursor indicates at least one currently selected cell; and
a lock cell input which immediately locks any cell currently selected by the cursor by changing a status of any currently selected cell to a locked status.

12. The device of claim 11, wherein said processor is further programmed to toggle the lock status of any cell currently selected by the cursor with the lock cell input.

13. The device of claim 11, wherein said processor is further programmed to indicate on the screen if at least one currently selected cell has a locked status.

14. The device of claim 11, wherein said processor is further programmed to include a cell lock indicator associated with the cell of any cell that has a locked status.

15. The device of claim 14, wherein said processor is further programmed to allow the user to turn off and on the cell lock indicator so that any cell that has a locked status will not be indicated in the cell when turned off and will be indicated when turn on.
